(19) United States
(12) Patent Application Publication
(10) Pub. No.: US 2004/0068414 A1
(43) Pub. Date: Apr. 8, 2004

(54) System and method for controlling pests

(76) Inventor: Jeffrey Springer, Cape Coral, FL (US)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/331,952

(22) Filed: Dec. 31, 2002

Related U.S. Application Data
(60) Provisional application No. 60/343,246, filed on Dec. 31, 2001.

(51) Int. Cl. G06F 17/60

(52) U.S. Cl. 705/1

(57) ABSTRACT

A system and method for providing pest control services. A contract specifying ongoing pest control services is concluded between a pest control service provider and a customer. The contract permits the pest control service provider to automatically debit a financial instrument of the customer on an ongoing basis without further intervention of the customer in exchange for repeatedly rendering pest control services.

### PRIORITY

This application claims the benefit of U.S. Provisional Patent Application Ser. No. 60/343,246 of the same title, filed on Dec. 31, 2001.

### FIELD OF THE INVENTION

The field of the invention is pest control services.

### BACKGROUND OF THE INVENTION

Known pest control services start with the application of pest control measures to eliminate an existing infestation, and can include follow-up inspections and services to prevent the infestation from recurring. Pest control measures can include inspection, treatment, baiting and monitoring. Inspection identifies the type, location and extent of an infestation. Treatment includes the application of chemical (e.g., pesticide) and non-chemical (e.g., caulking) measures to eliminate the infestation and to help prevent future infestations. Baiting includes setting stations having poisonous bait to further prevent a further infestation by reducing the population of pests. Monitoring includes periodic further inspections of the property and the bait stations to identify nascent problems so that they can be promptly treated.

FIG. 1 shows a known method of providing pest control services. A customer contacts a pest control service provider, step 101, typically after an infestation is detected. The pest control service provider concludes a one-time pest control agreement that often involves inspection and treatment of the problem, step 102. Although the agreement may entail several visits by the pest control service provider, the terms of the agreement are generally for a set course of a specified treatment for a fixed price. The course can be set by a number of visits or a fixed period of time the treatment can be specified for a particular type of pest (e.g., termites, ants, etc.) The customer is charged for the set course of treatment, step 103, and the service provider performs an inspection and treatment of the premises, step 104. Alternatively, the customer can pay for the set course of service after the service has been completed. It is known to provide a warranty in connection with the service agreement. The warranty can be renewed for a fee paid by the customer to the service provider. In exchange for the fee, the service provider performs one or more inspections during the term of the warranty. If reinfestation is detected, step 105, within the warranty period, step 106, then further inspection (as necessary) and treatment are applied, step 104.

Waiting until an infestation is detected to begin a program of pest control is curative, but not preventative. In other words, the problem is not prevented, but only treated after damage is already done. It can be disadvantageously more expensive, difficult and more intrusive to treat an existing infestation than to prevent an infestation in the first place. Further, it can be easier to assuredly prevent an initial infestation than to eradicate an existing one. Also, this approach disadvantageously adds the cost of repairing the damage done by the pest to removing the infestation. A curative approach can therefore be disadvantageously more expensive, intrusive, and less likely to succeed than a preventative approach.

### SUMMARY OF THE INVENTION

An embodiment of the present invention solves these problems by taking a preventative approach to pest control. It can provide mechanisms for regular preventative monitoring and treatment that is put in place before an infestation occurs. In one embodiment, the present invention includes concluding an agreement between a pest control service provider and a customer such that the customer automatically and regularly pays for periodic, ongoing inspections, monitoring and/or treatment by the service provider. If any infestation is discovered, the agreement specifies that the service provider apply the necessary treatment to eradicate or otherwise control the infestation at no further charge to the customer. An embodiment of the invention is essentially a subscription agreement for preventative pest control services, where the subscription fee covers any necessary curative treatment by the service provider.

An embodiment of the present invention advantageously provides predictable costs and peace of mind to the customer with regard to pest control. To contain costs associated with curative treatment, which are typically higher than implementing inspections and preventative measures, the service provider has an incentive to effectively prevent infestations, and therefore damage to the customer's property. The customer has an incentive to subscribe to the preventative services before an infestation is detected, particularly in areas known to have high rates of infestation, to prevent damage to her property, and to avoid the unpredictable and high costs associated with curing an existing infestation.

### BRIEF DESCRIPTION OF THE DRAWINGS

FIG. 1 is a flowchart showing an embodiment of the prior art.

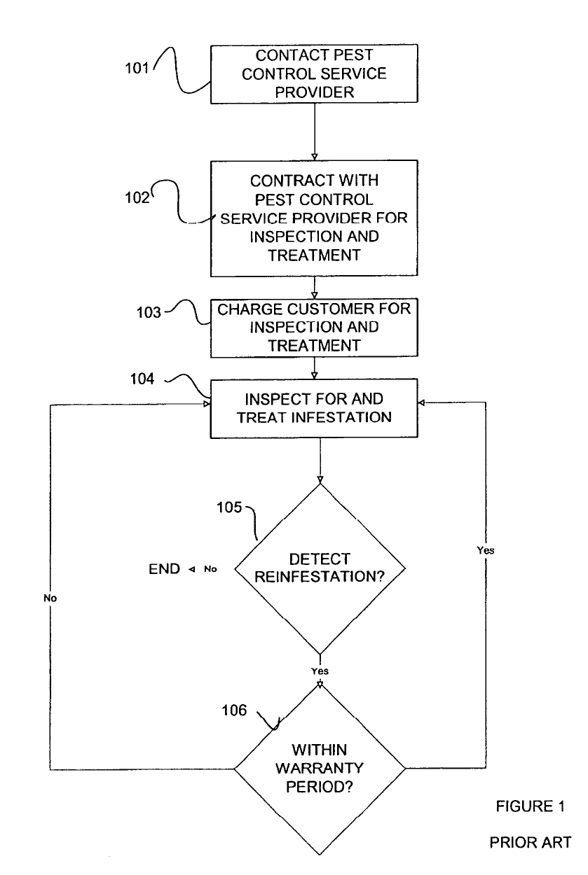

FIG. 2 is a flowchart showing the method in accordance with an embodiment of the present invention.

FIG. 3 shows an agreement in accordance with an embodiment of the present invention.

FIG. 4 shows a system in accordance with an embodiment of the present invention.

FIG. 5 shows a warranty in accordance with an embodiment of the present invention.

FIG. 6 shows an embodiment of the method in accordance with the present invention.

FIG. 7 shows an embodiment of a TermaPest monitoring station.

### DETAILED DESCRIPTION

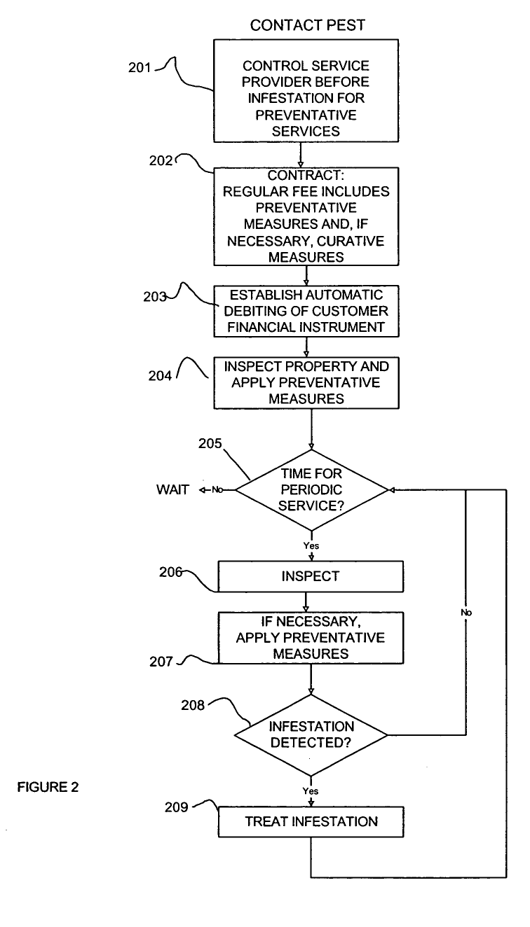

FIG. 2 is a flowchart that shows the method in accordance with an embodiment of the present invention. The customer contacts the pest control service provider before an infestation is detected for ongoing preventative pest control services, step 201. A contract is concluded between the customer and service provider for ongoing preventative services from the service provider and, if necessary, curative treatment of any detected infestation, in exchange for regular, ongoing payments from the customer to the service provider. In this embodiment, collection problems can be advantageously avoided by arranging to have a financial instrument of the customer (e.g., a credit card, checking account debit card, etc.) debited on a periodic basis, step 203, alternatively, the customer can be billed for the service. In one embodiment, the initial inspection and/or treatment may be free of charge, or else offered at a discount, when the customer subscribes to ongoing treatments. Alternatively, the customer's payment for the first inspection and treatment can be credited against the cost of future services provided to the customer.

The service provider inspects the property, and applies the appropriate preventative measures, step 204. As used herein, the term “preventative measures” includes any and all measures adapted to prevent an infestation of pests, such as the installation of pest monitoring stations, caulking, etc. An example of a monitoring station is a bait trap having a monitoring port for carbon dioxide. Of course, if an infestation is detected during the initial inspection, the service provider can apply the appropriate treatment.

The contract between the service provider and the customer (“the contract”) sets periodic inspections and preventative treatments (“service events.”) When it is time for the next service event, step 205, the service provider inspects the customer's property, step 206. For example, the service provider can gather data from the monitoring stations that have been installed at the customer's property; look for other signs of infestation; examine the condition of caulked seams and holes; etc. If necessary, the service provider can apply preventative measures, such as replacing monitoring stations, recaulking, applying preventative chemical treatments, etc., step 207. If an infestation is detected, step 208, then the service provider applies the appropriate treatment, step 209. If an infestation is not detected, then no action is ordinarily taken until the next service event is due under the contract, step 205. Naturally, if the customer detects a problem between service events, the customer can contact the service provider, who can provide the appropriate service in between scheduled service events.

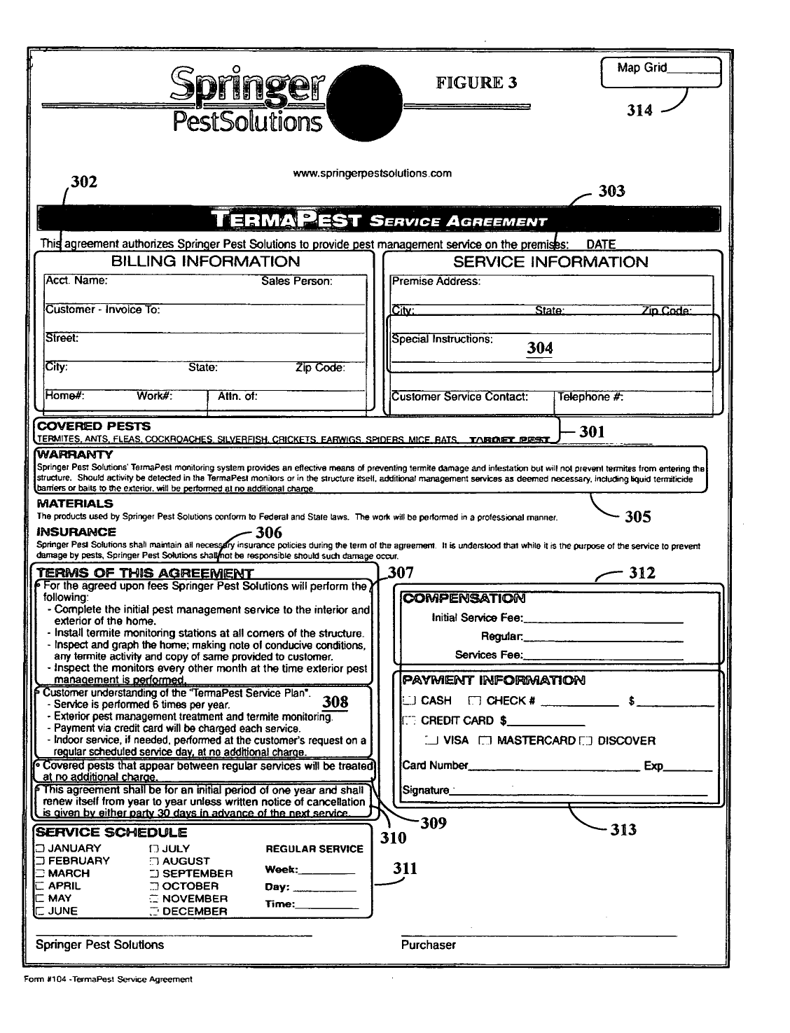

FIG. 3 shows a contract (a subscription agreement) between the service provider and the customer in accordance with an embodiment of the present invention. The scope of the contract is specified by circling one or more “Covered Pests,” 301, including termites, ants, fleas, cockroaches, etc. Customer billing information, 302, and service information, 303, are provided. Service information 303 can include special instructions, 304. Special instructions 304 can include acceptable times during the day at which to provide service; special conditions at the customer premise and any special treatment that is appropriate; or any other terms that are mutually agreeable to both the service provider and the customer.

A warranty, 305, states that the pest control “TermaPest” monitoring services will not prevent termites from entering the customer's building, and provides that additional pest control services, such as liquid termiticide barriers or baits, will be provided free of charge, if they are necessary to eradicated detected pests, provides for free additional service to manage termites within one year of the original date of treatment.

Terms of the contract 306 forth the obligations of the service provider, 307, who will: complete the initial pest management service to the interior and exterior of the customer's home; install pest monitoring stations at various locations on the property; inspect and graph the home, recording conditions conducive to infestation as well as any pest activity; and inspect the pest monitoring stations periodically.

The terms of the contract 306 also include the understanding of the customer, 308. The customer understands the frequency with which services will be performed (e.g., six times per year); the scope of the services (e.g., exterior pest management treatment and termite monitoring); the method of payment for each servicing (e.g., a credit card charge for each service visit, which can be implemented without having to obtain the customer's authorization for each charge); and that the customer has the option of requesting indoor service at no additional charge on a regular scheduled service day.

Covered pests that appear between regular services will be treated at no additional charge, 309. The term of the contract is for one year with automatic renewal for successive periods of one year, unless written notice of cancellation is given by either party 30 days in advance of the next service, 310. The service provider can also terminate the contract in the event of non-payment or default by the customer.

A service schedule 311 is provided to specify the months, week, day and time for servicing under the service program. Compensation is set 312 for the initial service fee, regular service fee and other services fee. Payment information is provided for, 313. Payment can be by prepayment for regular service for the whole year; automatic periodic charge to a credit card; automatic periodic charge to a checking account; automatic periodic charge to a credit account established with a positive balance by the customer at the service provider; etc. Payment authorization 313 advantageously provides authorization from the customer for ongoing, automatic debits to a customer financial instrument in payment for pest control services. This advantageously helps the service provider to avoid collections problems for services rendered.

The pest control services provided in accordance with an embodiment of the present invention can advantageously be for a combination of pests. For example, the contract can specify that comprehensive pest control services will be provided, e.g., for termites, ants, bees, etc. When the service provider conducts an initial inspection of the property, he produces a graph of the property that identifies areas of infestation, areas of opportunity for infestation, etc. After the initial inspection and treatment, the service provider can record on the property graph the date of the treatment, the location and conditions of monitoring stations, etc. After subsequent inspections, applications of preventative measures, etc., the graph can be advantageously updated to reflect the observed effectiveness of treatments, the elimination of areas of opportunity for infestation, the occurrence of new opportunities, new infestations, results from monitoring stations, etc. In this way, the graph documents the pest control history of the property as well as its present condition. The graph can advantageously be used by the pest control service provider to quickly become acquainted or reacquainted with a property so as to more effectively apply the appropriate treatments and conduct inspections. The graph can also include plans and instructions for future inspections and treatments, such as target dates for replacing monitoring stations. The graph can act as a comprehensive guide to the property for the pest control service provider, thereby advantageously saving time during reinspections and subsequent treatments. A reference to the graph, 314, can be included on the pest control service agreement.

The timing with which the pest control services are provided in accordance with the pest control program can be at regular intervals (e.g., on the third Wednesday of every other month at 3:00 PM); keyed upon other events (e.g., after more than one inch of rain falls in the area in less than one week, with a first frequency before the first hard frost and with a second frequency after the first hard frost until springtime, summer only, etc.); etc. The service contract can also specify a normal schedule as well as conditions under which the schedule is suspended. For example, if a drought extends beyond 45 days, then the schedule can be suspended until after the drought ends.

The service program can advantageously provide the customer with peace of mind by covering a comprehensive range of pests; by including recurring scheduled service events to monitor the customer's property and apply the appropriate treatments, if necessary; and by automatically debiting a financial instrument of the customer on a regular basis to pay for the program. In other words, the customer need not worry about pest control after concluding the pest control service program contact with the service provider, as regular and comprehensive pest control services are provided to the customer thereafter. Even payment takes place automatically.

A service program can advantageously be offered in accordance with different pricing plans. A basic service program can be offered at a first price, while add-on services can be offered for various premiums. For example, a basic program can cover ants and termites for a given price, and for an extra amount, the program can be extended to inspect and treat for wasps and other bees. The basic plan can be bundled with various premium offerings at an aggregate price that is less than the sum of the basic plan and each individual premium offering. This can provide an incentive for the customer to purchase a set of premium services along with the basic plan. Even related services, such as radon monitoring and/or treatment services (“radon services,”) can be delivered in conjunction with pest control services.

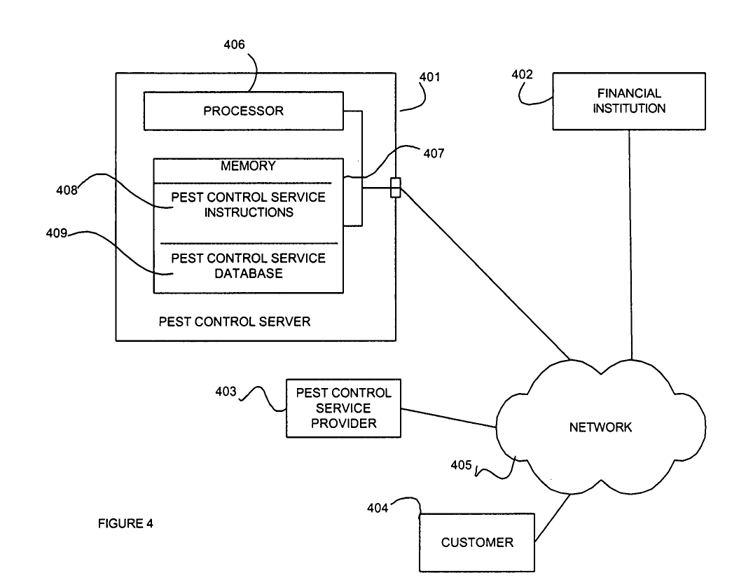

FIG. 4 shows a system in accordance with the present invention. A pest control server 401, a financial institution 402, a pest control service provider 403 and a customer 404 are coupled to each other through a network 405. The network can be a Local Area Network, a Wide Area Network, the Public Switched Telephone Network, the Internet, or any other electronic network.

The pest control server 401 includes a processor 406 coupled to memory 407. Processor 406 can be a general purpose microprocessor, such as an Pentium IV processor, made by the Intel Corporation of Santa Clara, Calif. Processor can also be an Application Specific Integrated Circuit (ASIC) that embodies at least part of the method in accordance with the present invention in hardware and/or firmware.

Memory 407 can be Random Access Memory (RAM), Read Only Memory (ROM) a hard disk, an optical storage device, or any other device adapted to store digital information. Memory 407 stores pest control service instructions (software) 408 that are adapted to be executed by processor 406 to perform the method in accordance with the present invention. For example, instructions 408 can include a graphical user interface adapted to be sent to customer 404. The user interface can facilitate the registration of a new customer with the pest control service provided by service provider 403 by permitting the customer to view and agree to the terms of a contract for preventative pest control services with a pest control service provider 403; receive and send preventative pest control service scheduling information from and to customer 404; receive and send preventative pest control monitoring and status information from customer 404; display the terms of a preventative pest control services contract executed between a pest control service provider and a customer; etc. The instructions 408 at server 401 can use the information provided through the interface to schedule visits to the customer for periodic inspections, treatments, etc. Instructions 408 can also automatically send debit and credit information to financial institution 402 for action with respect to a customer's account. For example, if a customer has subscribed to a pest control service that requires a payment at the end of every three months, the instructions 408 at server 401 can send a request to financial institution 402 to debit the customer's account at the end of January, March, June and September. Financial institution 402 can be a bank, a credit card company, or other type of company that handles the financial affairs of customers. The information pertaining to the pest control service can be stored in pest control service database 409.

The instructions 408 can be stored in any device adapted to store digital information, such as a floppy disk, RAM, ROM, a CD-ROM, etc., and be sent over a telecommunications channel, such as telephone lines, a cable system, the Internet, a LAN, wireless telecommunications links, etc. Instructions in such a device or in transit over telecommunications channels are said to be “contained in a medium.” That is, a medium containing the instructions includes any device storing the instructions, and communications channel carrying the instructions.

An embodiment of the present invention can operate as a franchise. A franchiser can provide national advertising, pest control supplies, training, and at least part of the hardware and software that makes up the pest control server 401 shown in FIG. 4. The franchisee can securely log in to the pest control server 401 to maintain account information, customer information, financial data, and inventory information, including supply chain data. Some of the information and services provided by the pest control server 401 can be made available only to the franchisee (e.g., pest control service provider 403,) while some can be available to both the franchisee and the customer 404. The pest control server 401 can facilitate two-way communications between the franchiser and franchisee.

The customer can advantageously be provided with reminders about upcoming service calls and helpful pest control information through pest control server 401. For example, pest control server 401 can act as a Web site that the customer 404 can visit through the network 405, which can be the Internet. Pest control server 401 can include e-mail server software and send e-mail reminders to customers about upcoming service calls, and send pest control information such as helpful tips (e.g., after a heavy rain, to remind customers to check for and empty any flooded monitoring stations), and special offers. Pest control information server can also provide an avenue of communication from the customer 404 to the pest control service provider 403. The customer can fill out a form (e.g., customer feedback) on a Web site hosted at the pest control server 401; send e-mail or an instant message to a pest control service provider 403; participate in an online chat with a pest control service provider 403 or other customers; etc. The pest control server 401 can also make available answers to Frequently Asked Questions (FAQs).

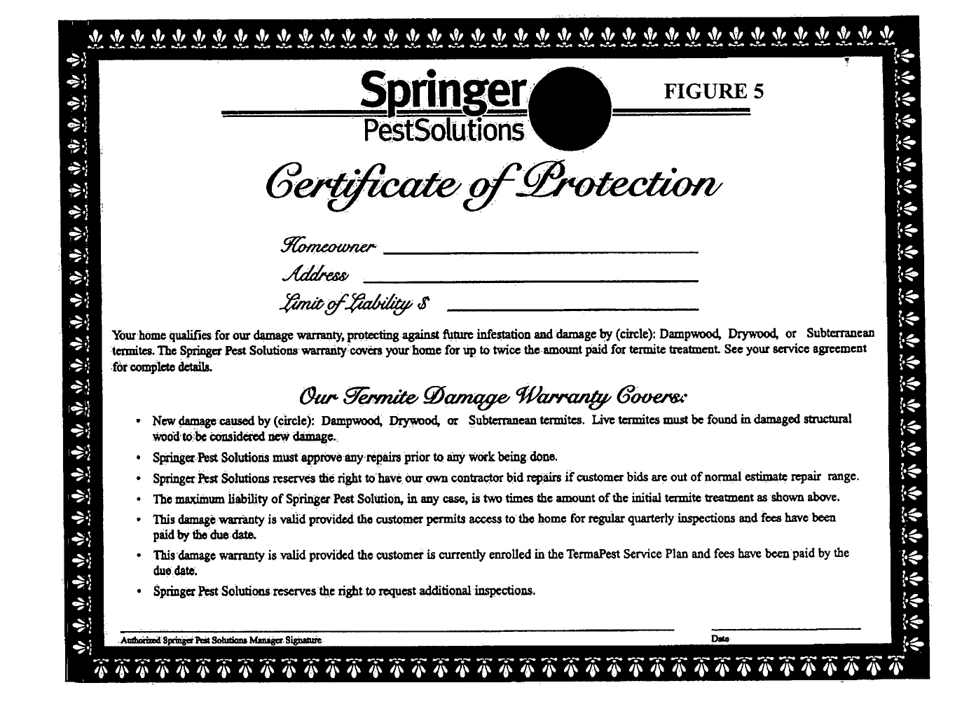

FIG. 5 shows a detailed pest damage warranty made by the service provider. The warranty provides that the service provider will pay to repair damage to the customer's property from one or more of the specified types of termites, but limits the maximum liability of the service provider to an amount equal to two times the amount paid by the customer for the initial treatment.

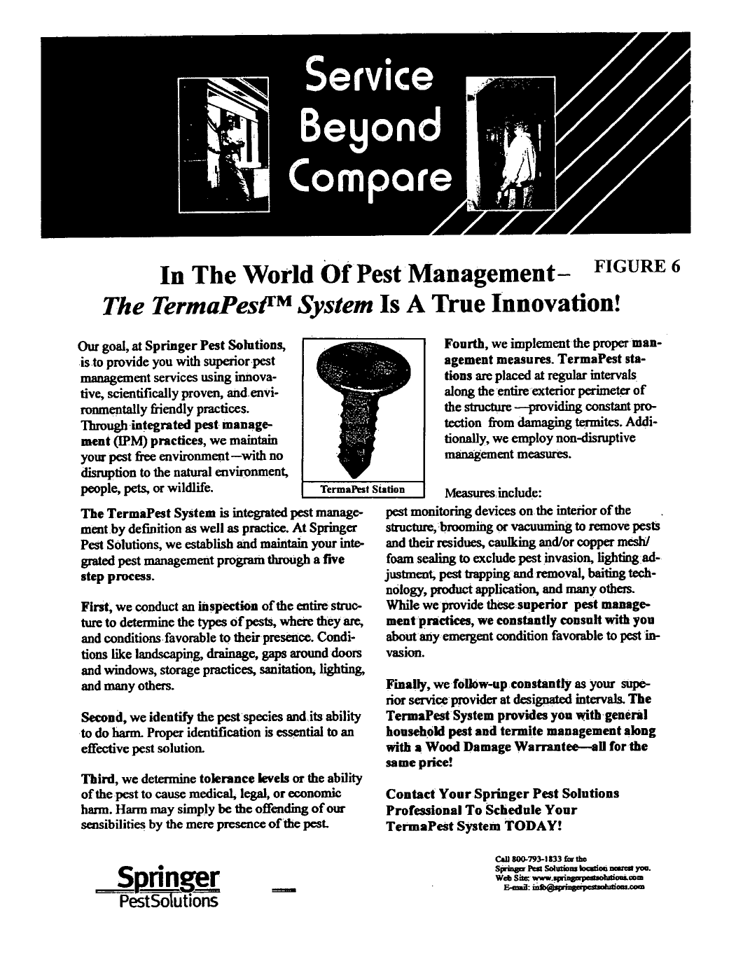

FIG. 6 shows the method in accordance with an embodiment of the present invention. First, the service provider conducts an inspection of the customer premises to determine the types of pests, their locations, and to identify conditions (e.g., landscaping, drainage, gaps around doors and windows, storage practices, sanitation, lighting, etc.) that are favorable for the pests. The species of the pests are identified, as are the types of harm that the pests can cause. The appropriate pest control services are identified and implemented, such as placing TermaPest stations around the property. The pest control service provider returns at regular intervals to ensure that pests are under control. All of these services are included under a single, integrated pest control program as set forth in the pest control service contract (see FIG. 3.)

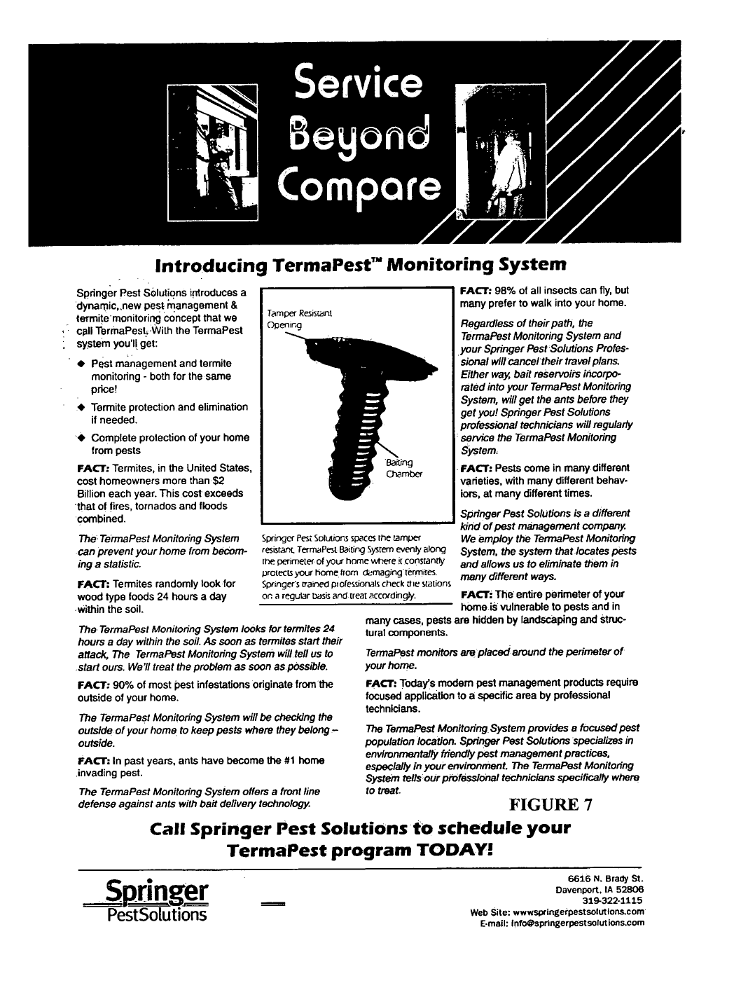

FIG. 7 shows a TermaPest monitoring system. Poisonous bait is contained in a baiting chamber, which is advantageously provided with a threaded exterior to facilitate its placement in the ground, and tamper-resistant opening through which pests can enter and leave the chamber. The chamber can also be advantageously provided with a port through which a carbon dioxide monitoring probe may be inserted. Elevated carbon dioxide levels inside the chamber can indicate the presence of pests.

The present invention can advantageously introduce new efficiencies into the provision of pest control services, including comprehensive pest control, recurring service events under a pest control contract, and automatic debiting for such service events of a customer's financial instrument. One of ordinary skill in the art will appreciate that the above description are examples meant to illustrate, and not to limit, the full scope of the invention, which encompasses other embodiments that fall within the teaching and spirit of the description and claims.

What is claimed is:

1. A method for providing pest control services, including:
agreeing to provide pest control services to a customer periodically in accordance with a contract;
automatically billing a financial instrument of the customer in accordance with the terms of the contract;
periodically providing pest control services to the customer in accordance with the terms of the contract.

2. The method of claim 1, further including agreeing to provide radon services to a customer.

3. The method of claim 1, wherein the financial instrument of the customer is a credit card.

4. The method of claim 1, wherein the financial instrument of the customer is a checking account.

5. The method of claim 1, wherein pest control services are provided to a customer every other month.

6. The method of claim 1, wherein the contract is a subscription agreement between a pest control service provider and a customer, wherein the pest control service provider agrees to provide pest control services to the customer on an ongoing basis, and the customer agrees to permit the repeated debiting of a customer financial instrument in payment for the pest control services.

7. A system for providing pest control services, including:
a processor;
a memory coupled to said processor, said memory storing pest control service instructions adapted to be executed by said processor to automatically debit a financial instrument of a customer in accordance with the terms of a contract.

8. The system of claim 7, wherein said pest control service instructions are further adapted to be executed by said processor to repeatedly debit a financial instrument of a customer according to a predetermined schedule.

9. The system of claim 7, wherein said pest control service instructions are further adapted to be executed by said processor to receive an indication that pest control services have been rendered to the customer, and in response to debit a financial instrument of a customer without any intervention by the customer.

10. The system of claim 7, wherein said pest control service instructions are further adapted to be executed by said processor to provide a graphical user interface that displays a date on which a service event is scheduled to be performed for a customer.

11. The system of claim 7, wherein said pest control service instructions are further adapted to be executed by said processor to provide a graphical user interface that displays the results of an inspection at a customer location.

12. The system of claim 7, wherein said pest control service instructions are further adapted to be executed by said processor to provide a graphical user interface that displays terms of the contract executed between a pest control service provider and a customer.

13. The system of claim 7, wherein said pest control service instructions are further adapted to be executed by said processor to send a message to a financial institution to debit a financial instrument of a customer.

14. The system of claim 13, wherein said financial instrument is a credit card.

15. The system of claim 7, wherein said pest control service instructions are further adapted to be executed by said processor to provide a graphical user interface through which a customer can view the terms of and agree to a pest control service contract.

16. A medium containing instructions adapted to be executed by a processor to perform steps including:
agreeing to provide pest control services to a customer periodically in accordance with a contract;
automatically billing a financial instrument of the customer in accordance with the terms of the contract;
periodically providing pest control services to the customer in accordance with the terms of the contract.

17. The medium of claim 16, further including instructions adapted to be executed by a processor to receive an indication that pest control services have been rendered to the customer, and in response to debit a financial instrument of a customer without any intervention by the customer.

18. The medium of claim 16, further including instructions adapted to be executed by a processor to provide a graphical user interface that displays a date on which a service event is scheduled to be performed for a customer.

19. The medium of claim 16, further including instructions adapted to be executed by a processor to provide a graphical user interface that displays the results of an inspection at a customer location.

20. The medium of claim 16, further including instructions adapted to be executed by a processor to provide a graphical user interface through which a customer can view the terms of and agree to a pest control service contract.

21. A system for providing pest control services, including:
means for specifying pest control services to be provided to a customer, and the time period over which said services are to be provided;
means for automatically billing a financial instrument of the customer for providing the pest control services.

22. The system of claim 21, further including a graphical user interface through which a customer can view the terms of and agree to a pest control service contract.

23. The system of claim 21, further including means for receiving an indication that pest control services have been rendered to the customer.
